(19) United States
(12) Patent Application Publication
(10) Pub. No.: US 2003/0098010 A1
(43) Pub. Date: May 29, 2003

(54) Method and device for controlling the idle operation of a drive unit

(76) Inventor: Mario Kustosch, Markgroeningen (DE)

Correspondence Address: KENYON & KENYON, ONE BROADWAY, NEW YORK, NY, 10004, US

(21) Appl. No.: 10/240,069

(22) PCT Filed: Feb. 13, 2001
(86) PCT No.: PCT/DE01/00533

(51) Int. Cl. F02D 1/00

(52) U.S. Cl. 123/339.11

(57) ABSTRACT

A method and a device for controlling the idle speed of a drive unit are proposed, where a controller influences the ignition angle of an internal combustion engine as a function of the deviation between an actual and a setpoint quantity. This controller has at least one variable parameter which, in operating phases in which it is not desired to advance the ignition angle, assumes a quantity that differs from that in normal operation and restricts the effect of the intervention in the ignition angle.

### BACKGROUND INFORMATION

The present invention relates to a method and a device for controlling the idling of a drive unit.

Such a method, or such a device, is known from the European Patent 33 616 A1, for example. In this case, an idle-speed controller is proposed which, as a function of the deviation of the measured engine speed from a specified setpoint value, influences the air supply of an internal combustion engine via a first intervention path, the ignition angle of the internal combustion engine via a second path, in order to approximate the rotational speed to the specified setpoint speed.

Apart from controlling for comfortable, precise speed at idling, modern control systems attempt to enable the catalytic converter used for emission control to convert at the earliest possible moment, so that a fully functioning catalytic converter and its attendant advantages are already available in the start phase of the internal combustion engine, or shortly thereafter. For this reason, the catalytic converter must be brought to operating temperature very rapidly. Different concepts are available for this purpose, one of them using secondary air to heat the catalytic converter. In this case, a chemical reaction is initiated by adding fresh air to an incompletely combusted mixture in the exhaust gas. This process is also known as exothermic. The exothermic process relies to a large extent on a late ignition firing point. Changes in the ignition firing point, in particular advance ignitions, can lead to a termination of the exothermic process. The ignition firing point can be influenced in such a manner particularly during the start phase by the idle-speed controller, since it is intent on bringing the variable to be controlled to the setpoint value.

From the European Patent 77 997 B1, an idle-speed controller is known, which has at least one proportional-action component, whose output signal influences the air supply to an internal combustion engine as a function of the speed deviation. To improve the functioning method of the idle-speed controller, the speed deviation is fed to a dead-zone member, which will not emit an output signal within a specified speed range. If the speed deviation is within this dead-zone range, no control intervention takes place. The size of the dead-zone range is selected to be slightly larger than the natural measure of deviation of the idling speed. This promotes stabilization of the control and improves ride comfort.

From the German Patent 41 41 946 A1, a procedure for heating a catalytic converter using secondary air is known. The secondary-air supply is begun and ended as a function of time and/or operating parameters. For instance, the secondary-air supply, and thus the operating phase of the catalytic-converter heating, is initiated when the internal combustion engine is started, or subsequent to the lapsing of a specified period of time after the internal combustion engine has started, or as a function of exceeding a specified threshold value for the engine speed. The catalytic-converter heating phase is terminated when a specified time since the start of the phase has elapsed, the time period being a function of speed, engine load, the sum of the supplied air mass, or a combination of both values, or the fuel quantity injected up to that point, the temperature of the internal combustion engine, the temperature of the catalytic converter and/or the temperature of the induction air.

### SUMMARY OF THE INVENTION

The influence of the idle-speed control on the ignition-firing point during the catalytic-converter heating phase or a selected part thereof, is suppressed or restricted. In this way, the exotherms are stabilized in an advantageous manner. The catalytic-converter heating function and the idle-speed controller do not work against each other.

It is particularly advantageous to restrict the influence of the ignition-firing point of the idle-speed controller only in certain ranges of the variable to be controlled, such as in speed ranges. In this manner, a satisfactory stability of the idle-speed control, the idling speed, for instance, is achieved in this operating range as well, and a stalling of the engine prevented, since an intervention in the ignition-firing point is still possible, especially in response to significant control deviations.

This is achieved advantageously by setting the magnitude of the control parameter(s), especially its (their) amplification factor, within the desired operating range, preferably within a predefined speed range, to small values, preferably zero, greater values being assumed for larger deviations. This is advantageously realized by an appropriately predefined characteristic curve.

The result is a compromise between a stable exothermic process and stable idling, which leads to an altogether satisfactory operational performance of the drive-unit control.

In an advantageous manner, this approach is used not only in connection with catalytic-converter heating, but additionally, or alternatively, also with other concepts where a retarded ignition-firing point is an essential prerequisite. This is the case, for instance, in control concepts where a lean mixture is supplied to the internal combustion engine during warm-up. Here, too, the influence of the idle-speed control on the ignition-firing point is thus suppressed or restricted for the duration of warm-up, or a part thereof.

Further advantages are derived from the following description of exemplary embodiments and from the dependent claims.

### BRIEF DESCRIPTION OF THE DRAWINGS

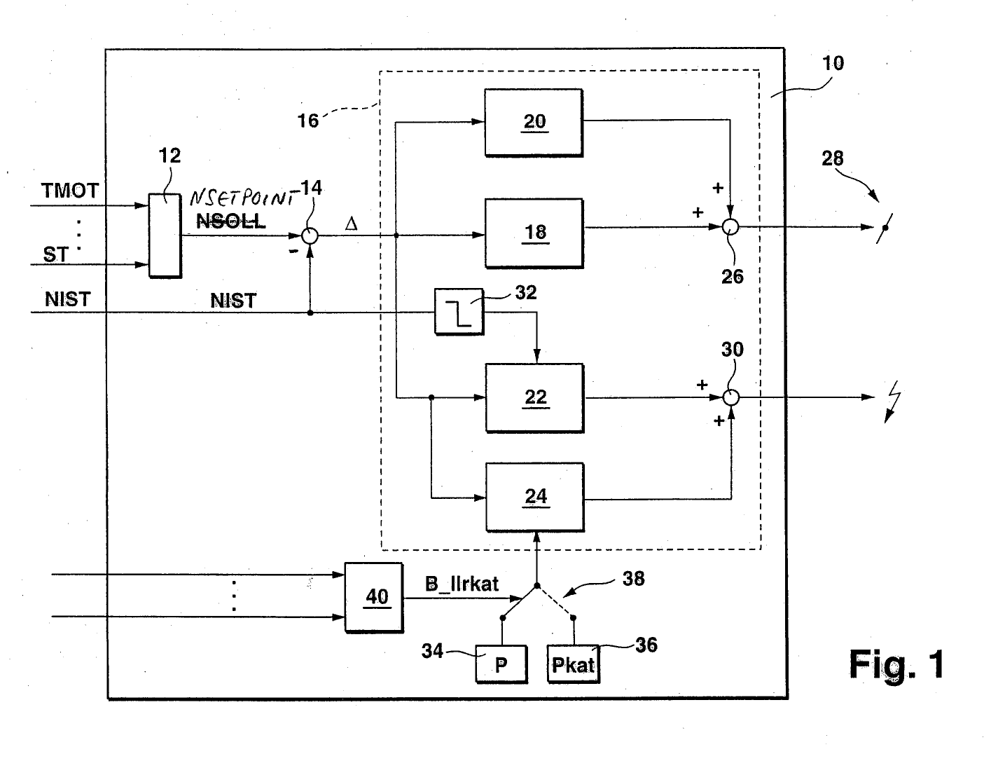

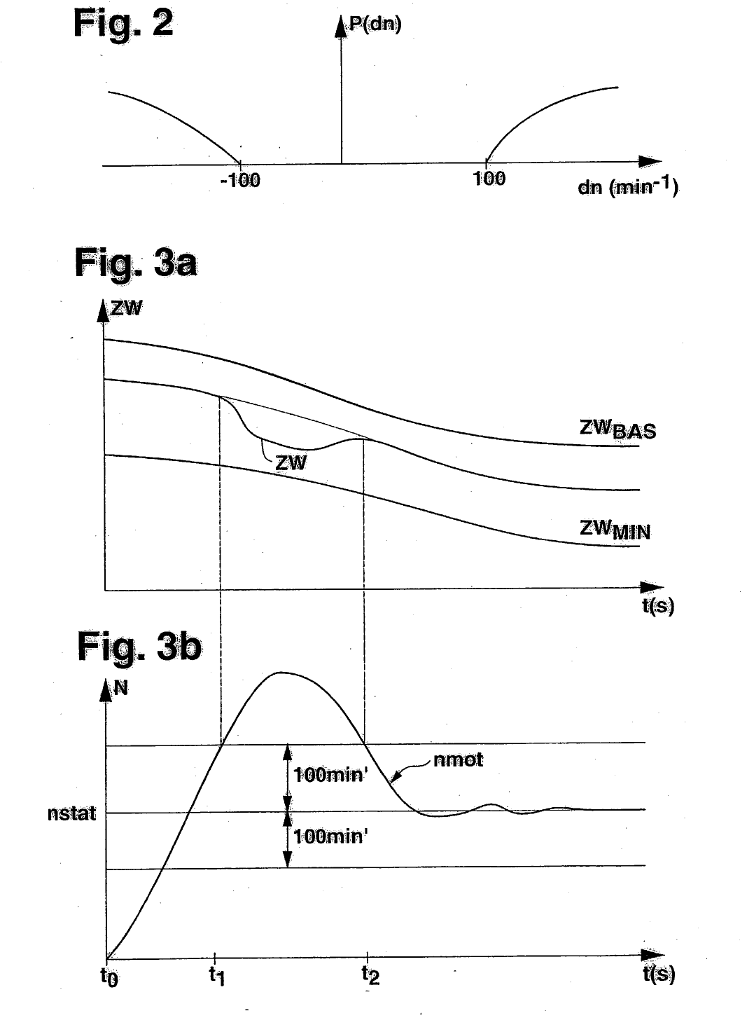

The present invention is elucidated below on the basis of the specific embodiments shown in the drawing. Its FIG. 1 shows a flow diagram of an idle-speed controller, including air- and ignition-angle intervention; while FIGS. 2 and 3, on the basis of diagrams, show the effect of influencing the controller parameters for a preferred embodiment.

### DESCRIPTION OF THE EXEMPLARY EMBODIMENTS

FIG. 1 shows a flow diagram of an idle-speed controller, which influences the air supply to an internal combustion engine as well as its firing angle in the sense of bringing the actual speed closer to the setpoint speed. In the preferred embodiment, this flow chart represents a program of a microprocessor, which is part of a control unit for controlling the internal combustion engine. In this context, the depicted blocks represent programs or program steps, the connecting lines the flow of information. In FIG. 1, this control unit, or this microprocessor, is denoted by the reference numeral 10. Appropriate measuring devices, not shown in FIG. 1 for reasons of clarity, supply signals representing performance quantities to control unit 10, i.e., microprocessor 10. A signal amplitude representing engine speed NIST is supplied via a first input line. Signals for other performance quantities of the engine, or the vehicle, such as engine temperature TMOT, status ST of auxiliary load circuits, for example climate control, vehicle speed VFZ etc., are supplied via additional input variables. Microcomputer, or control unit 10, also receives a signal indicating that the ignition switch has been switched on (alternatively: activation of the engine starter or actuation signal of the supply voltage). Given a switched-on control unit, the setpoint-idle speed NSETPOINT is calculated in a setpoint-former 12 as a function of supplied performance quantities, such as engine temperature and/or the status of at least one ancillary component. Depending on the exemplary embodiment, this is accomplished on the basis of characteristic curves, performance characteristics, tables or computation steps. In a preferred embodiment, setpoint former 12 is implemented as a program of microcomputer 10. In a reference point 14, deviation A between the setpoint idle-speed NSETPOINT formed in this manner and the detected actual speed NIST is then formed. This system deviation is then fed to idle-speed controller 16, which is represented by the dotted line.

In a preferred exemplary embodiment, this idle-speed controller 16 is essentially made up of a conventional PID controller (a controller having proportional, differential and integral action components), at least one component, preferably the P- and/or the D-component, being implemented twice. In the shown variant, a PID controller acts on the charge (air supply), a PD controller (only proportional- and differential-action component) on the ignition angle. In a preferred exemplary embodiment, the differential-action component for the ignition-angle path is only active at speeds that are well below the idle speed. Therefore, the proportional-action component for the ignition-angle path is decisive for the idle-speed controller's influence on the ignition angle. In the preferred exemplary embodiment, the output signal of the proportional-action component is formed from the product of speed deviation Δ and a characteristic curve. This characteristic curve is a function of the speed deviation, the parameter (proportionality factor) of the characteristic curve being selected such so as to provide stable performance characteristics for the engine speed. In this context, the factor may change as a function of the magnitude of the system deviation. The factor represents the gradient of the characteristic curve. In other embodiments, the D-component is active in all speed ranges. In addition, in other exemplary embodiments, other types of controllers are used as well, at least one variable parameter always being provided that affects the dynamic performance of the controller.

In the flow diagram in FIG. 1, the system deviation is fed to an integral-action component 18, a proportional- and differential-action component 20, in each case for the air path, to a differential-action component 22 and to a proportional-action component 24 for the ignition-angle path. The system deviation is appropriately evaluated in the individual controller components, integrated in integrator 18, differentiated in the differential-action components, and amplified in the proportional-action components, in the afore-mentioned manner. The output signals from the controller component are brought together for the charge- and the firing-angle path in each case. Thus, the output signal from integrator 18 and the output signal from the proportional/differential-action component 20 are combined in node 26 (added, for instance) and transmitted as an output signal to an electrically actuable throttle valve 28 in order to control the air supply, for instance. Analogously, the output signal from differential-action component 22 and that from proportional-action component 24 for the ignition-angle path are combined in a node 30 (added, for instance), and the resulting signal is transmitted via an output line in order to adjust the firing angle, the output signal representing a correction signal for a basic ignition angle possibly corrected by other performance quantities.

In addition, a threshold-value step 32 is provided, which receives a signal representing engine speed NIST. If this engine speed is very low, this threshold-value step 32 generates a signal which activates differential-action component 22 of the ignition-angle control. If this engine speed exceeds the threshold value checked in threshold-value step 32, the differential-action component is deactivated again.

Two different values, or characteristic curves, are stored in memory locations 34 and 36 for proportional-action component 24 of the ignition-angle control, one for normal operation and one for the catalytic- converter heating phase. In addition, a switching element 38 is provided, which is switched from the normal setting, represented by the solid line, to the start position, depicted by the dotted line, by a signal B_LLRKAT, which is active during the heating phase of the catalytic converter of the internal combustion engine. This signal is formed in signal former 40 on the basis of selected performance quantities. In the manner described at the outset, in the cited related art, for instance, the onset and the end of the heating phase of the catalytic converter are determined in signal former 40, on the basis of at least one supplied performance quantity. If the system is in the catalytic-converter heating phase, the appropriate signal is output by signal former 40, and switching element 38 is switched. During the catalytic-converter heating phase, the proportional-action component of the ignition-angle controller is, therefore, determined in accordance with the amplification stored in memory location 36, or the characteristic curve stored therein, as a function of the speed deviation, which differs from the normal-operation values in that the influence of the ignition angle of the controller is at least partially suppressed or restricted.

An example of the characteristic curve stored in memory location 36 is shown in FIG. 2. This characteristic curve holds especially for the proportional-action component of the ignition-angle controller for the operating phase of cat-heating. During this operating phase, the characteristic curve is used as an alternative to the normal characteristic curve, which is stored in memory location 34. As soon as the cat-heating phase has ended, which is determined, for instance, on the basis of the related-art method described in the introduction, the normal parameter record is selected to control the idling speed. FIG. 2 shows the profile of amplification factor P as a function of speed deviation DN (=Δ) between the setpoint engine speed and the actual engine speed. To the advantage of the cat-heating function, this characteristic curve has data applied in such a way that the amplification factor is zero within a predefined speed range, between −100 and 100 rpms, for instance. In this way, the ignition-angle profile in this speed range remains unaffected by the idle-speed controller. A smooth ignition-angle curve, in turn, allows a stable exotherm and thereby ensures optimal cat-heating. In a preferred exemplary embodiment, amplification factor P increases monotonically outside of this specified speed range, in order to ensure that the idle speed remains stable. The greater the system deviation, the more effective the intervention in the ignition angle is. This ensures satisfactory stability of the idle speed.

It has been shown in other exemplary embodiments that a small value of the proportional amplification factor is useful in the specified speed range. In this manner, a minimal change in the ignition angle is allowed even during an active cat-heating function, so that a further improvement in idle-speed stability is possible without substantially restricting the heating function of the catalytic converter.

If, in addition to a proportional-action component, the ignition-angle controller also includes a differential-action component that is also active in the normal speed range and/or an integral-action component, corresponding characteristic curves for the catalytic-converter heating operation are provided for these components as well.

In a preferred exemplary embodiment, the characteristic curve for the amplification factor in normal operation is unaffected by the magnitude of the speed deviation i.e., the value of the amplification factor remains the same for all speed-deviation magnitudes. If a dependence on the system deviation is provided here as well, the values for the amplification factor are greater than they are during special operation, at least in the afore-mentioned speed range.

Specifying a particular parameter record at least for the proportional-action component of the ignition-angle controller of an idle-speed controller is not only limited to the catalytic-converter heating phase, but is used in other exemplary embodiments, additionally or alternatively to the catalytic-converter heating phase, in all those operating phases in which a retarded ignition angle is essential for the functioning, for instance, during warm-up using lean mixture. In this case, the procedure described above is used during the warm-up phase, or for an essential part of the warm-up phase.

The preferred exemplary embodiment relates to a speed controller. In other embodiments, variables other than speed are also controlled, for example, the torque of the drive unit, etc. In this variant, the variable to be appropriately controlled (torque, power output etc.) is detected, compared to a setpoint value and influenced as a function of the deviation of the ignition angles. Analogously to FIG. 2, the at least one parameter of the controller is then correspondingly reduced, at least in one specified deviation range, in order to restrict the action of the controller in the special-operation state.

FIG. 3 shows the time characteristics of ignition angle ZW (FIG. 3a) and of engine speed NMOT (FIG. 3b) during the start phase of an internal combustion engine. In the operating phase shown, the above-described catalytic-converter heating function is carried out, so that the characteristic curve sketched in FIG. 2 is used for the ignition-angle intervention controller. The ignition angle is at a specified value between basic ignition angle ZWBAS and a minimum ignition angle ZWMIN (FIG. 3a). At instant TO, the engine speed rises, enters the speed range formed about setpoint idling speed NSTAT (FIG. 3b). In this phase, the ignition angle remains unchanged, since the proportional-action component is determined according to FIG. 1, and an intervention in the ignition angle is in any case only activated when the setpoint speed is exceeded for the first time. At instant T1, the engine speed leaves the speed range, so that, according to FIG. 3a, an ignition-angle change in the advance direction in this period takes place to decrease the engine-speed overshoot. At instant T2, the speed once again enters the speed range in which the proportional-action component is inactive, and from thereon remains in this speed range (FIG. 3b). Therefore, according to FIG. 3a, beginning with instant T2, no further intervention in the ignition angle is implemented.

What is claimed is:

1. A method for controlling the idle speed of a drive unit, the deviation between a variable, to be controlled, of the drive unit, and a specified value for this variable being formed, as a function of which, an actuating signal that influences the ignition angle of the drive unit is generated by a controller (16) having at least one variable parameter (P), wherein, in special operating phases, where an advancing of the ignition angle is not desired, the magnitude of the at least one parameter (P) of the controller (16) is varied with respect to normal operation, so that the effect of the controller (16) on the ignition angle is at least restricted.

2. The method as recited in claim 1, wherein the operating phase is the catalytic-converter heating phase or the warm-up phase of an internal combustion engine, to which lean mixture is supplied.

3. The method as recited in one of the preceding claims, wherein the variable to be controlled is the rotational speed of the drive unit, a torque of the drive unit or its power output.

4. The method as recited in one of the preceding claims, wherein the at least one parameter, during the special operation phase, or at least for a part of this phase, has a value that is smaller within than it is outside of the same, of a predefined range of the variable to be controlled.

5. The method as recited in claim 4, wherein the smaller value is zero.

6. The method as recited in claim 4 or 5, wherein the specified range is a specified value range of the deviation from the zero value.

7. The method as recited in one of the preceding claims, wherein a switch is made to the parameter used in normal operation once the operating phase, or the part of the operating phase in which the parameter is varied, is complete.

8. A device for controlling the idle speed of a drive unit, comprising a controller (16) which generates an actuating variable that influences the ignition angle of the drive unit as a function of the deviation of a variable, to be controlled, of the drive unit, from a setpoint quantity predefined for this variable, and the controller (16) having at least one variable parameter (P), wherein switching means (38) are assigned to the controller (16), which, given a special operating phase in which it is not desired to advance the ignition angle, switch the at least one parameter (P) to a quantity that differs from normal operation, so that the effect of the controller (16) on the ignition angle is at least restricted.
